(19) United States
(12) Patent Application Publication
(10) Pub. No.: US 2005/0024044 A1
(43) Pub. Date: Feb. 3, 2005

(54) Angular positioning sensing system and method

(76) Inventors: Norman Poirier, Raynham, MA (US); Gerald Tromblee, Hanover, MA (US)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 10/627,407

(22) Filed: Jul. 25, 2003

Related U.S. Application Data
(60) Provisional application No. 60/398,774, filed on Jul. 26, 2002.

(51) Int. Cl. G01B 7/30

(52) U.S. Cl. 324/207.25

(57) ABSTRACT

An angular positioning sensing system is provided including a rotary sensor configured to provide an absolute phase angle position. The rotary sensor may include a rotatable magnet and two, or more, magnetic field sensors spaced around an axis of rotation of the magnet. The output of the magnetic field sensors may be coupled to a phase angle pulse modulation circuit and a PWM to analog circuit.

### CROSS-REFERENCE TO RELATED APPLICATIONS

This application claims the benefit of U.S. provisional application Ser. No. 60/398,774, filed Jul. 26, 2003, the entire disclosure of which is herein incorporated by reference.

### FIELD OF THE INVENTION

The present invention relates generally to a pulse width modulated to analog signal circuit, and in particular to the use of such a circuit in a broader rotary sensor system application. In addition, a balanced sensor for sensing the absolute phase angle position of a rotating object is also provided. In addition, various mechanical and magnetic steering wheel sensors are provided.

### BACKGROUND OF THE INVENTION

A variety of transducers, including rotary sensors, may produce sine and cosine signals based on the angle of rotation of a monitored device. The monitored device may be any device that moves in a rotary fashion over a 0 to 359 degree range, e.g., a steering wheel or a valve to name only a couple. From the sine and cosine input signals, the angle of rotation needs to be extracted.

A common method of extracting the angle of rotation, or θ, from sine θ and cosine θ signals is to encode each signal into a digital signal and then use a software routine, e.g., CORDIC routine, to extract θ. Essentially, the software routine solves the arctangent of the ratio of the sine θ and cosine θ values as detailed in equation (1).
θ=ARC TAN (SIN θ/COS θ) (1)

In order to extract θ using this method, it is necessary to convert an analog signal to a digital signal, e.g., via an A/D converter, to use some microprocessor or microcomputer to run the stored software routine, to store the software routine in memory, and to output the results via a D/A converter. A hardware alternative for extracting a phase angle from sine and cosine signals could be accomplished by a quadrature modulation scheme as further detailed herein which produces a pulse width modulated signal (PWM) having a characteristic repetition rate of ωt and a pulse width proportional to the phase angle θ.

To obtain θ from the PWM signal, such a signal can be passed through a low pass filter to obtain its dc average, which is directly proportional to the phase angle θ. Although this low pass filter technique may be acceptable in some instances, it has the disadvantage of having a poor response speed, particularly when the phase changes from 360 to 0 degrees, a full range step. Increasing the cutoff frequency of the low pass filter does improve the response time, but it also allows ripple from the modulation frequency to contaminate the desired output. Accordingly, there is a need for a PWM to analog signal circuit to provide for improved response time over a low pass filter. In addition, there is a need for a balanced angular position sensor to sense the absolute angular position of a rotating object.

### SUMMARY OF THE INVENTION

According to one aspect, a phase angle detection system is provided including a rotary sensor including a magnet rotating about an axis and a plurality of magnetic field sensors angularly spaced about the axis. The system also includes a phase angle pulse modulation circuit and PWM generator circuit coupled to an input signal provided by each of the magnetic field sensors, and a PWM to analog signal circuit coupled to an output of the phase angle pulse modulation circuit and PWM generator circuit.

According to another aspect of the invention, a rotary sensor system is provided including a permanent magnet coupled to a rotational input, the magnet rotatable about an axis, and three magnetic sensors generally evenly spaced around said axis. The magnetic sensors are configured to provide respective first, second and third outputs equal to A cos(θ), A cos(θ−120°), and A cos(θ−240°) in response to and angular displacement, θ, of the magnet.

According to still another aspect, a shaft coupling configuration is provided for a rotary sensor system, the shaft coupling including a magnet/rotor assembly rotatably coupled an input shaft, the magnet rotor assembly including a Geneva cam feature including a first diameter about approximately 180° and a second diameter for approximately 180°. A magnet tray is disposed adjacent to said magnet/rotor assembly, the tray including at least one pin adapted follow the Geneva cam feature and to translate the tray relative to said magnet/rotor assembly in response to the first and second diameter of the Geneva cam.

### BRIEF DESCRIPTION OF THE DRAWINGS

Advantages of the present invention will be apparent from the following detailed description of exemplary embodiments thereof, which description should be considered in conjunction with the accompanying drawings, in which:

FIG. 1 is a simplified block diagram of a control system utilizing a phase angle detection system consistent with the present invention;

FIG. 2 is a block diagram of one exemplary phase angle detection system including a two-magnet sensor coupled to a phase angle pulse modulation circuit and a PWM to analog signal circuit consistent with the invention;

FIG. 3A is an exemplary circuit diagram of the PWM to analog signal circuit of FIG. 2;

FIG. 3B is a timing diagram for the circuit of FIG. 3A;

FIG. 4 is plan view of an exemplary balanced sensor having three magnetic sensors for sensing the absolute position of a rotating object;

FIG. 5 is a block diagram of an exemplary signal processing system for the balanced sensor of FIG. 4; and

FIG. 6 is a circuit diagram of one exemplary embodiment of the signal processing system of FIG. 5.

FIGS. 7-8 are back and front perspective views, respectively, of an exemplary sensor assembly consistent with the present invention;

FIGS. 9-11 illustrate exemplary magnet configurations for a sensor assembly consistent with the invention;

FIGS. 12-13 are plots illustrating performance of one exemplary magnet assembly consistent with the invention; and

FIGS. 13-15 are plots illustrating performance of another exemplary magnet assembly consistent with the invention.

### DETAILED DESCRIPTION

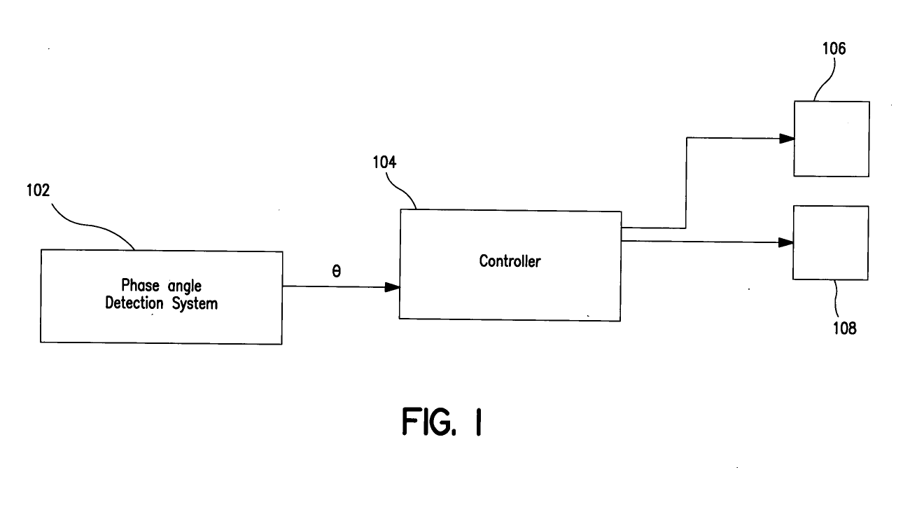

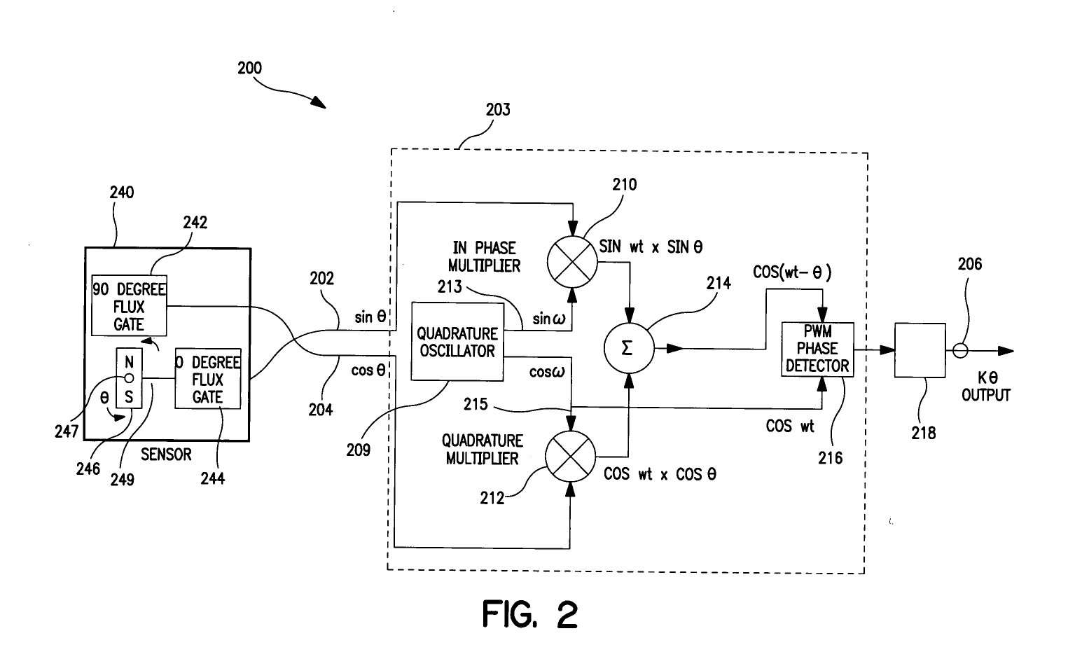

FIG. 1 is a simplified block diagram of a control system 100 utilizing a phase angle detection system 102 consistent with the present invention. Those skilled in the art will recognize a variety of control applications for a phase angle detection system 102 consistent with the present invention. It is to be understood, therefore, that the embodiments described herein are described by way of illustration, not of limitation. One such control system 100 may include a phase angle detection system 102 for detecting the position of a steering wheel. The phase angle detection system 102 may include a sensor part, a phase angle pulse modulation circuit, and a PWM to analog signal circuit consistent with the invention as further detailed with reference to FIG. 2.

When used in a steering wheel application, the phase angle detection system 102 produces the angular position or phase angle θ of the steering wheel between 0 and 359 degrees. This phase angle θ of the steering wheel may then be provided to a controller 104 of the vehicle. The controller 104 may then utilize this phase angle θ data in a variety of vehicle systems 106, 108.

Such systems may include automatic braking system 106 where breaking is influenced by the position of the steering wheel. Other such systems may include a traction control system 108 where engine responsiveness and other items are also influenced by the position of the steering wheel. Such phase angle θ position data of the steering wheel may also be used to assist in turn signal activation and deactivation. For example, if the steering wheel has been relatively straight for a predetermined time and distance interval, a turn signal may be automatically deactivated.

Turing to FIG. 2, a block diagram of one exemplary phase angle detection system including a two-magnet rotary sensor 240 coupled to a modulator and PWM generator circuit 203 and a PWM to analog signal circuit 218 consistent with the invention is illustrated. The sensor 240 may include a permanent magnet 246 having a north and south pole that rotates about a center axis 247. The rotating magnet type sensor may include a first magnetic field sensor 244 located at 0 degrees relative to a direction line 249 from the center axis 247. The rotating magnet type sensor may also have a second magnetic field sensor 242 located at 90 degrees relative to the same direction line 249 from the center axis 246.

The magnetic field produced by the magnet 246 is thus sensed by the sensors 244, 242 as the magnet rotates from 0 degrees to 359 degrees relative to the direction line 249. The varying magnetic field sensed by the first sensor 244 is 90 degrees out of phase with the varying magnetic field sensed by the second sensor 242 as the magnetic rotates. As such, the first sensor 244 produces the sine input signal, e.g., sin θ, and the second sensor 242 produces the cosine input signal, e.g., cos θ, depending on the angular position θ of the magnet.

The sine input signal and cosine input signal are then input to the modulator and PWM generator circuit 203 via respective input paths 202 and 204 to an in phase multiplier 210 and a quadrature multiplier 212. A quadrature oscillator 209 may generate a first generated signal, sin ωt. This sin cot signal may also be provided to the in phase multiplier 210, via a separate first oscillator input path 213. Similarly, the quadrature oscillator 209 may also generate a second generated signal, cos ωt, that may be provided to the quadrature multiplier 212 via a second oscillator input path 215.

The in phase multiplier 210 multiplies the input sine signal from the transducer 208 by the first generated signal, sin cot, from the quadrature oscillator 209 to produce sin θ×sin ωt. Similarly, the quadrature multiplier 212 multiplies the input cosine signal from the transducer 208 by the second generated signal, cos ωt, from the quadrature oscillator 209 to produce cos θ×cos ωt. Both signals, (sin θ×sin ωt) and (cos θ×cos ωt), may then be summed together by adder circuit 214.

The adder circuit produces a summed signal, [cos(ωt−θ)] in accordance with Equations (2)-(4) below
sin θ×sin ωt=½[cos(ωt−θ)−cos(ωt+θ)] (2)
cos θ×cos ωt=½[cos(ωt−θ)+cos(ωt+θ)] (3)
[½[cos(ωt−θ)−cos(ωt+θ)]]+[½[cos(ωt−θ)+cos(ωt+θ)]]=[cos(ωt−θ)] (4)

The summed signal [cos(ωt−θ)] is a sinusoid signal having an angular frequency of ωt and a phase shift angle of θ. The signal [cos(ωt−θ)] may then be provided to a PWM phase detector 216. The PWM phase detector 216 may also accept the cos ωt signal from the quadrature oscillator 209.

The PWM phase detector 216 provides a PWM signal having the characteristic repetition rate of ωt and a pulse width proportional to the phase angle θ. For example, a pulse width of 0% could represent a phase angle θ of 0 degrees, while a pulse width of 100% could represent a phase angle θ of 360 degrees.

Such PWM signal is then provided to the PWM to analog signal circuit 218 consistent with the invention, which is configured to provide a fast response method of acquiring the phase angle θ.

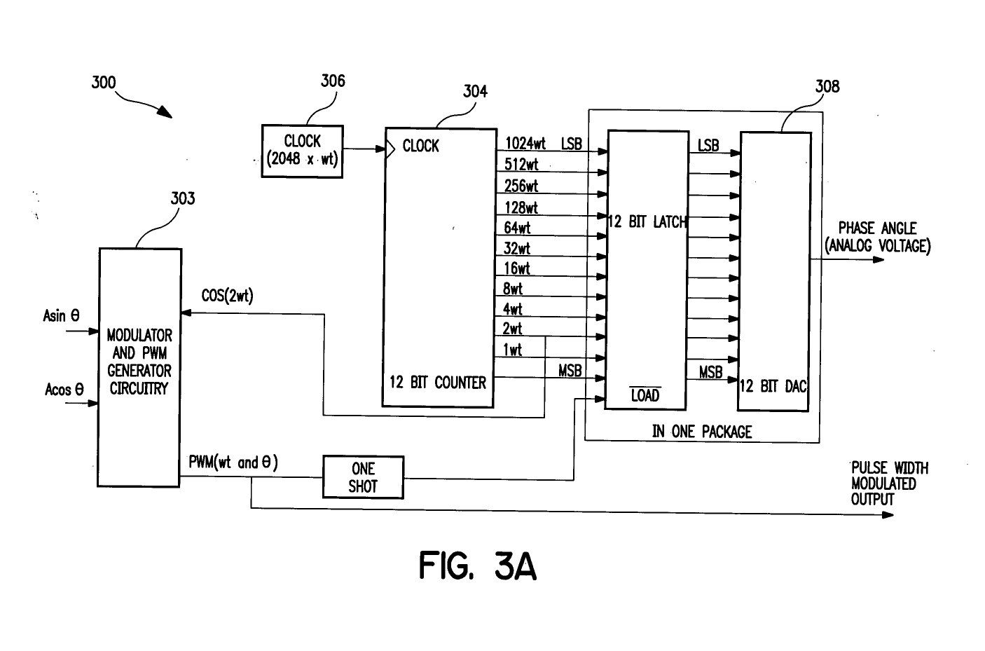

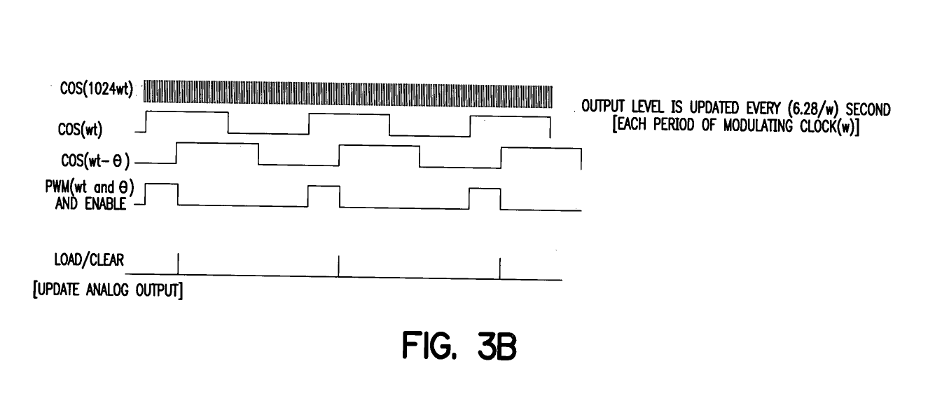

Turning to FIG. 3, an exemplary circuit diagram 300 of the PWM to analog signal circuit of FIG. 2 is illustrated. An input sine signal and cosine signal is provided to the modulator and PWM generator circuit 303. As previously detailed with reference to FIG. 2, such a circuit provides a PWM signal or PWM (ωt and θ). A 12 stage binary counter 304 is driven from a clock 306. The clock may operate a high frequency, e.g., 2048×ωt. The output states of the counter 304 may be continuously presented to the input of a 12 bit digital-to-analog converter 308. One stage, e.g., stage 11, of the counter 304 may be taken to generate the modulation signals Bsinωt and B cosωt, which as previously detailed produce Bcos(ωt−θ).

The leading edge of this delayed modulation signal is used to transfer and latch the output state of the binary counter to the output of the DAC 308. Thus, the phase angle θ is quantized into 2048 analog states. Advantageously, the data output is updated for each cycle of the modulation clock. The processing produces a relatively instantaneous response to the 360 to 0 degree step changes. The maximum delay is one period of the modulating clock or ½ πωt.

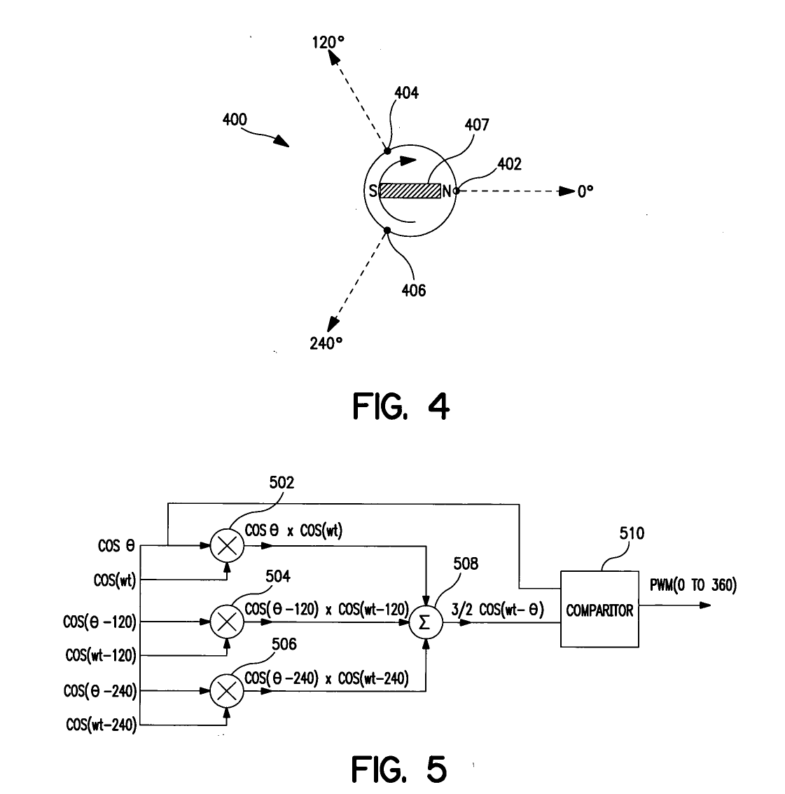

Turning to FIG. 4, an embodiment of a balanced sensor 400 having three magnetic sensors 402, 404, and 406 for sensing the absolute position of a rotating object 403 is illustrated. The three magnetic sensors 402, 404, and 406 are advantageously positioned in a spatially symmetrical configuration about the rotating object 403. In other words, the sensors 402, 404, and 406 are spaced at 120-degree intervals about the rotating object 403. A permanent magnet 407 is affixed or coupled to the shaft. In one of many exemplary systems, the rotating object 403 may be the shaft of the steering wheel column of a vehicle such that the absolute position sensor 400 senses the absolute angular position θ of the steering wheel. As previously described with reference to the vehicle control system of FIG. 1, this steering wheel position data may be input to a host of other vehicle systems

As the object 403 (and hence the magnet 407) rotates, the first sensor 402 produces a first signal equal to A cos(θ), where θ is the angular displacement of the rotating object 403 from the “0 degree” position established by the first sensor 402. In turn, the second sensor 404 produces a second signal equal to A cos(θ−120°). Finally, the third sensor 406 produces a third signal equal to A cos(θ−240°).

Turning to FIG. 5, an exemplary system 500 for processing signals from the sensor 402, 404, 406 of FIG. 4 is illustrated. Those skilled in the art will recognize a variety of other ways to process such signals.

First, the three signals (cos(θ), cos(θ−120°)) and cos(θ−240°) are respectively input to three separate multiplying circuits 502, 504, and 506. The first multiplying circuit 502 multiplies the cos(θ) signal from the first magnetic sensor 402 by a high frequency square wave cos(ωt). The second multiplying circuit 504 multiplies the cos(θ−120°) from the second magnetic sensor 404 by a high frequency square wave cos(ω−120°). Finally, the third multiplying circuit 506 multiplies the cos(θ−240°) from the third magnetic sensor 406 by a high frequency square wave cos(ωt−240°).

The product from each multiplying circuit 502, 504, 506 is then input to the adding circuit 508 to produce 3/2 cos(ωt−θ) as detailed from the trigonometric identities and equations below.

Using the trigonometric identity cos(x)*cos(y)=½ cos(x−y)+½ cos(x+y)
cos(wt)*cos(θ)=½ cos(ωt−θ)+½ cos(ωt+θ) 1.
cos(ωt−120°)*cos(θ−120°)=½ cos(ωt−θ)+½ cos(ωt+θ−240°) 2.
cos(ωt−240°)*cos(θ−240°)=½ cos(ωt−θ)+½ cos(ωt+θ−480°) but −480°=−120° therefore 3.
cos(ωt)*cos(θ)=½ cos(ωt−θ)+½ cos(ωt+θ−120°) 3.
Summing 1, 2, and 3, yields:
Sum=3/2 cos(ωt−θ)+½ (cos(ωt+θ)+cos(ωt+θ−120°)+cos(ωt+θ−240°) but another trigonometric identity 4.
cos(x)+cos(x−120°)+cos(x−240°)=0, therefore,
Sum=3/2 cos(ωt−θ), a signal consisting of the modulating signal delayed by the phase angle, θ 5.

As compared with an orthogonal two magnetic sensor system as previously described with reference to FIG. 2 which gave a result of cos(ωt−θ), the detected signal 3/2 cos(ωt−θ) from the balance absolute position sensor 400 produces a signal that is 50% larger. This translates to a 3.5 dB improvement in signal to noise.

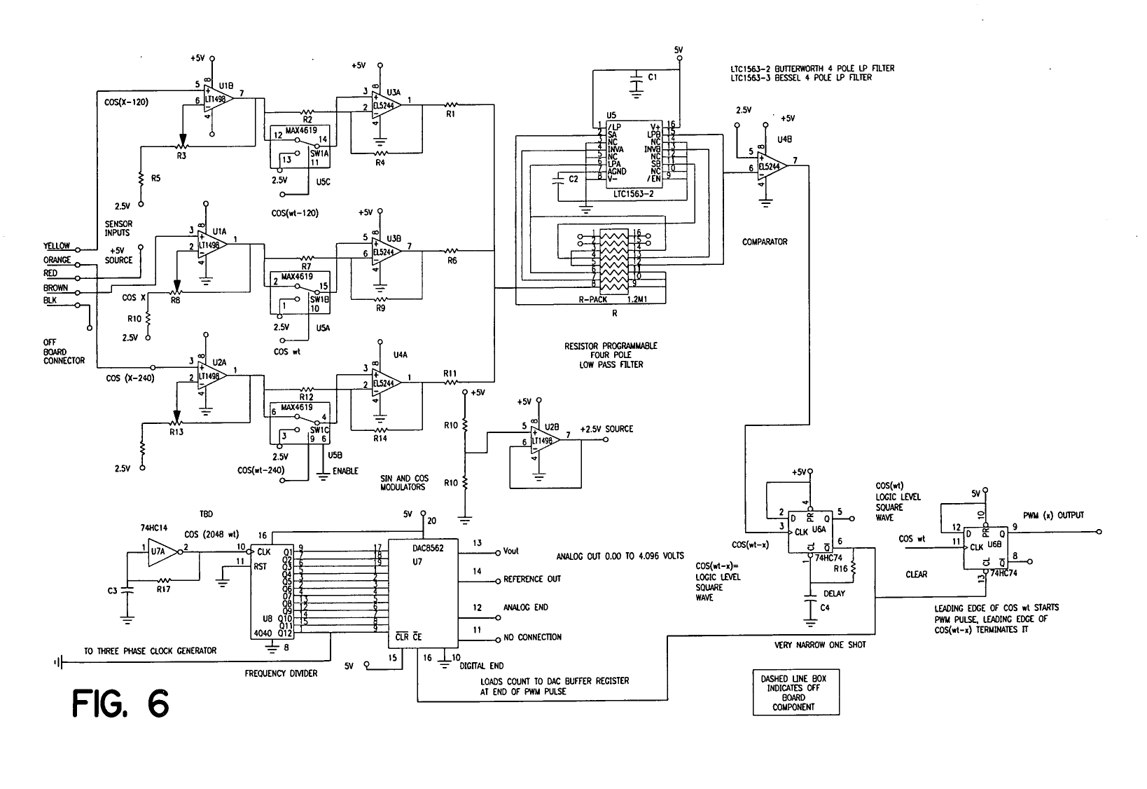

Error analysis also indicates a significant improvement to sensitivity to dc offsets in the outputs of the sensors 402, 404, and 406 (this error is totally eliminated in the three phase system). Also, in analyzing output errors due to changes in sensitivity of one of the sensors, results indicate that a sensitivity change of 1% produces a 0.6° error in the two-phase system as opposed to a 0.37° error in the three-phase system. An exemplary circuit diagram of the signal processing system of FIG. 5 is illustrated in FIG. 6.

According to another aspect of the invention, a novel shaft coupling configuration is provided. The accuracy of a Steering Angle Sensor depends partly on maintaining the concentricity between the Magnet/Rotor Assembly and the Sensor Housing Assembly. For most conventional applications the Sensor Housing Assembly is mounted on the Steering Shaft and thus this concentricity can be difficult to control. Consistent with one aspect of the present invention the coupling may be provided to maintain the required concentricity between the Magnet/Rotor Assembly and the Sensor Housing Assembly while at the same time allowing up to 0.75 mm axial misalignment between the Sensor Housing and the Steering Shaft.

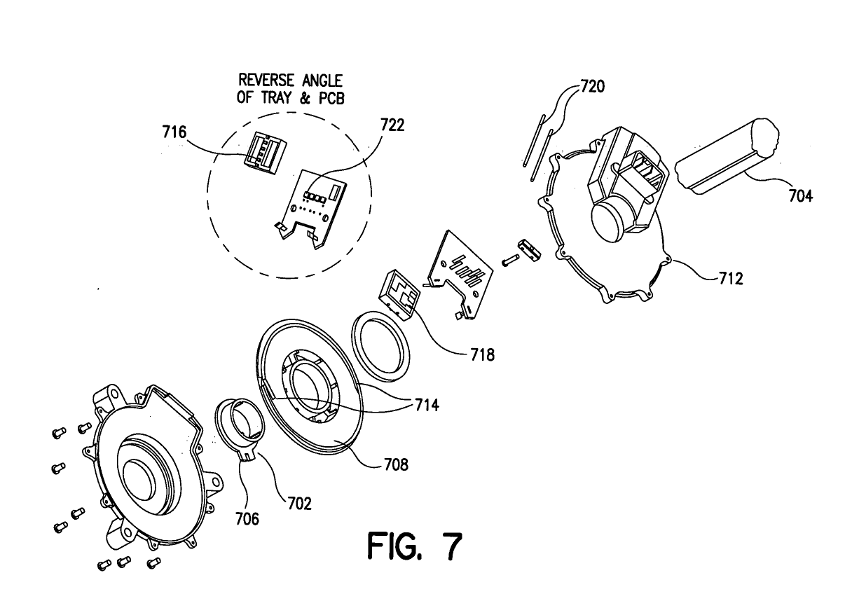

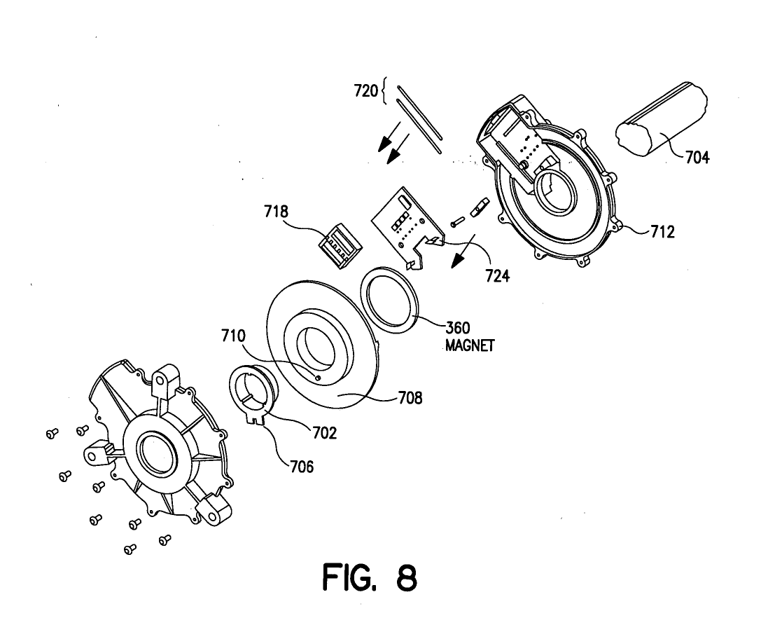

With reference to FIGS. 7 and 8, the coupling 702 attaches firmly to the Steering Shaft 704 allowing no radial or rotary movement relative to the shaft 704. The slot in the tab 706 of the coupling 702 engages and turns the Magnet/Rotor Assembly 708 via a pin 710 in the Sensor Housing Assembly 712, turning the Magnet/Rotor Assembly 708 as the Steering Shaft 704 rotates. The rotational error between the Steering Shaft 704 and the Magnet/Rotor Assembly 708 is partially a function of their concentricity, which is made as small as possible, and the distance from the center of the Steering Shaft 704 and the pin 710 in the Sensor Housing Assembly 712, which is made as large as possible.

According to another aspect of the invention, there is provided a novel Geneva Cam/ grey code magnet design for a multi-turn output. This design provides a digital grey code output that may used to determine the absolute angle of a multi-turn rotary sensor. Referring still to FIGS. 7 and 8, the Geneva cam feature 714 that is part of the molded Magnet/Rotor 708 changes diameter every 180 degrees rotation. For the remainder of the 180 degrees the cam 714 is at a fixed radius. This cam 714 engages the row of pins 716 on the back of the Grey Code Magnet Tray 718 which then translates along the Guide Rails 720. The spacing of the pins 716 may be equal to the spacing of the Grey Code Magnet 722, so that when the Magnet/Rotor 708 rotates and a transition point is reached, the Grey Code Magnet/Tray 718 moves along the Guide Rails 720 an amount equal to the Grey Code Magnet spacing. One of the transitions may be open to allow for the changing from one pin to the next on the Grey Code Magnet/Tray 718.

The Grey Code Magnet/Tray 718 may be a pattern of alternating North and South poles magnetized through the thickness of the magnet. For a four turn output determination, 9 distinct positions are required in the grey code, therefore a four channel magnet and four digital magnetic sensors are needed. The Magnetic sensors may be located on the PCB 724 above each of the four magnet channels. The Grey Code Magnet/Tray 718 shown in the illustrated exemplary embodiment is for resolving a 4 turn absolute rotary position.

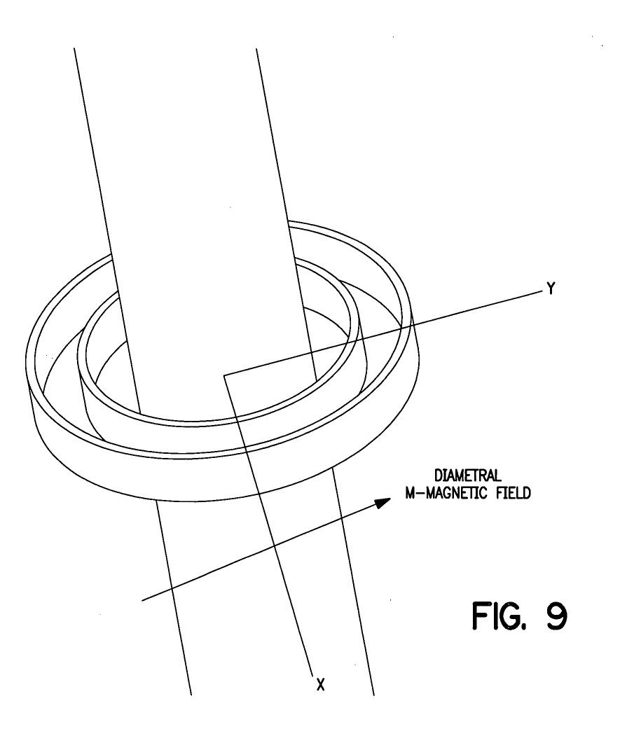

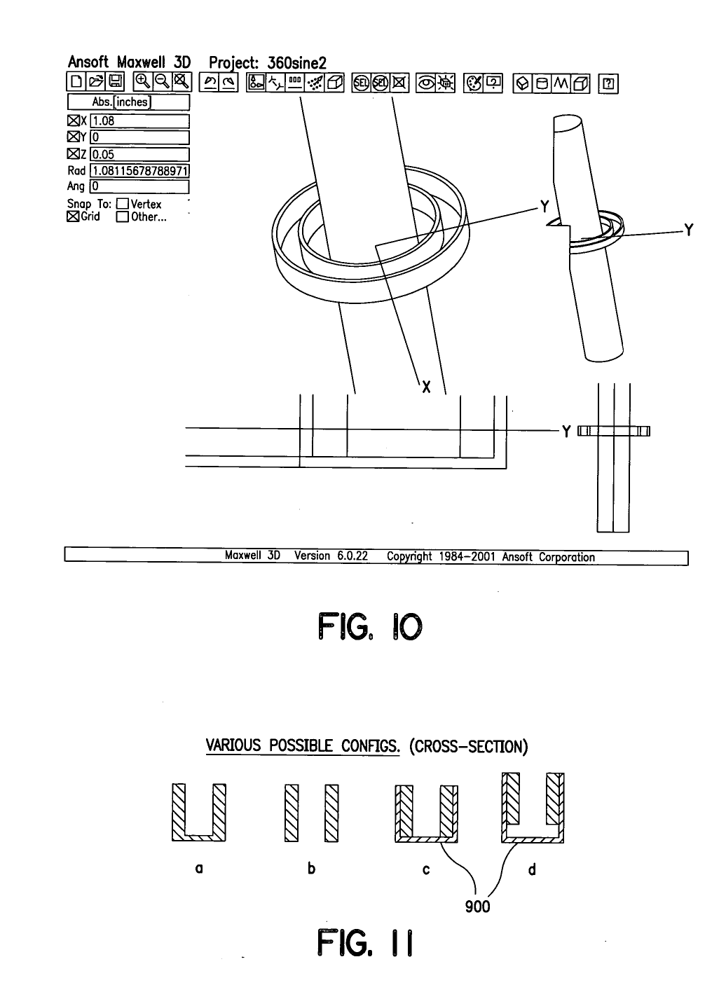

With reference now to FIGS. 9-15, according to a further aspect of the invention, there is provided a U-channel magnet design for minimizing eccentric and axial offset errors. This design allows for eccentric and axial movement of the magnet with respect to the sensor with minimal change of gauss. This eliminates the need to provide a mechanical means reduce the effect of this movement on the accuracy of the sensor.

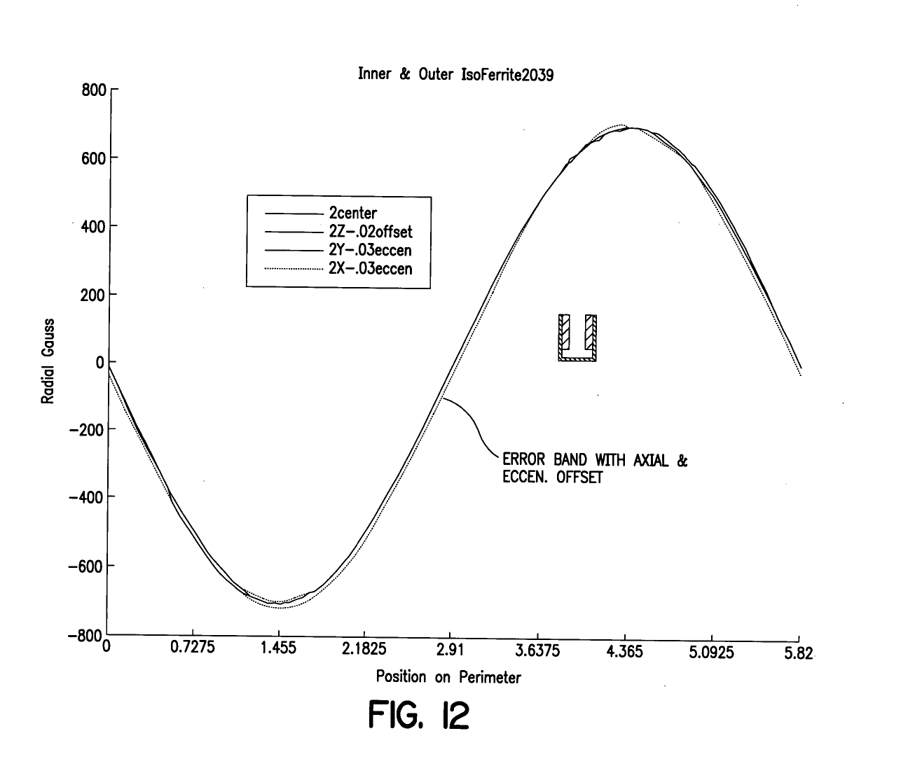

Various magnet cross sections for minimizing offset errors are possible, as shown in FIG. 11. A U-channel magnet configuration, as shown in cross sections a and b, minimizes offset errors. The further addition of a steel U-channel outer cover, 900 in cross-sections c and d, may provide two additional advantages. First, the gauss levels are increased for the same magnet size. Second, because the magnetic circuit is almost closed it is less likely to pick up debris, such as paper clips or any other debris.

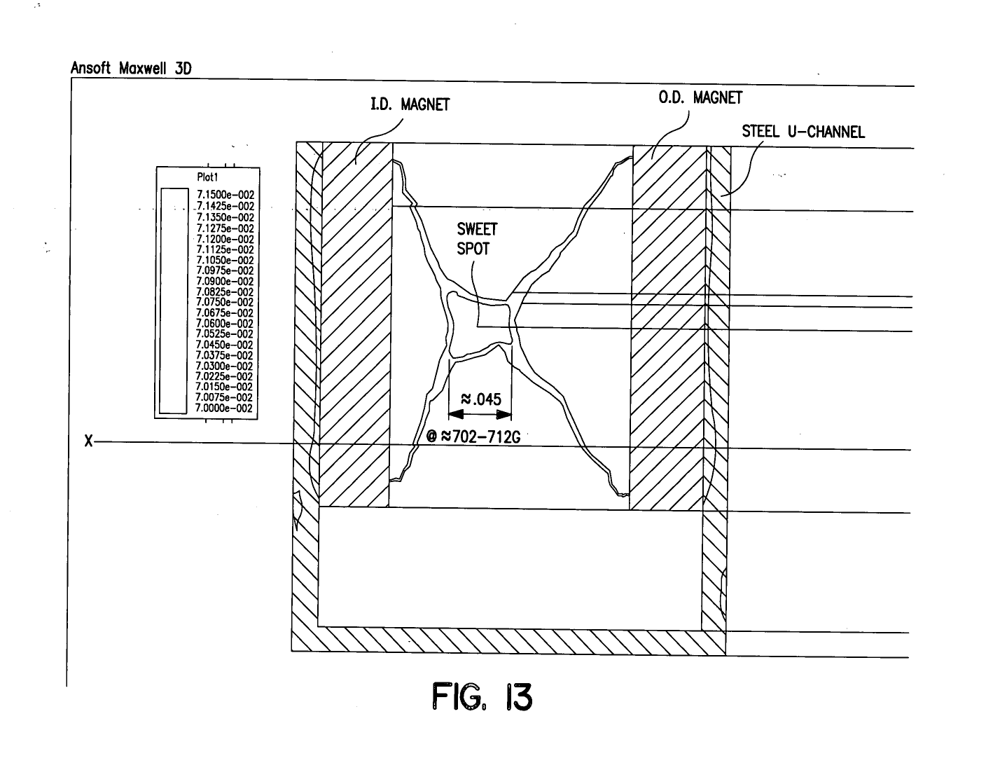

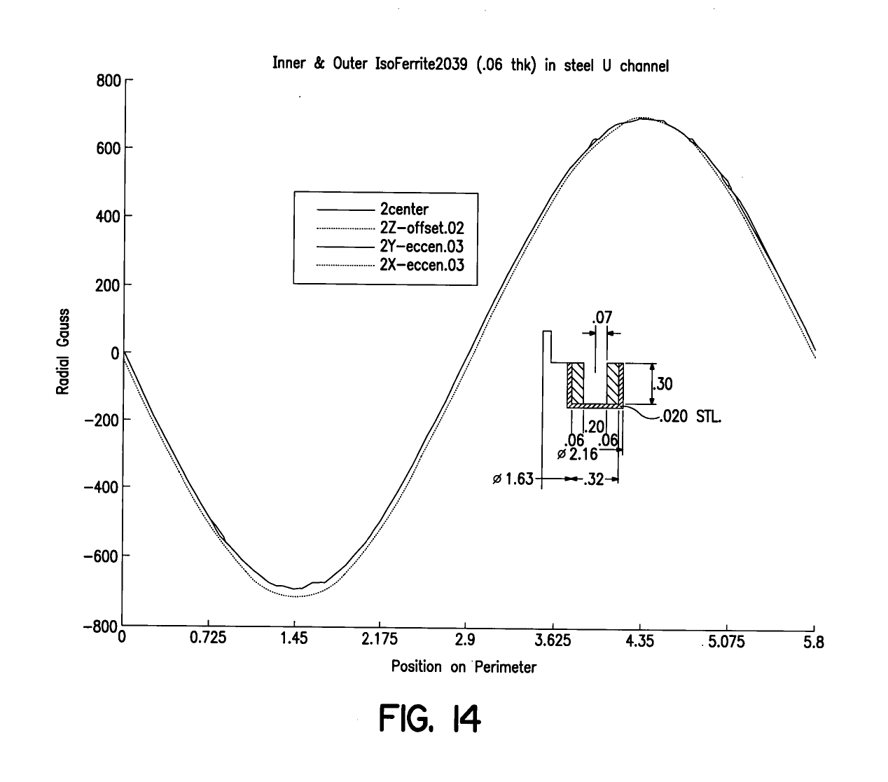

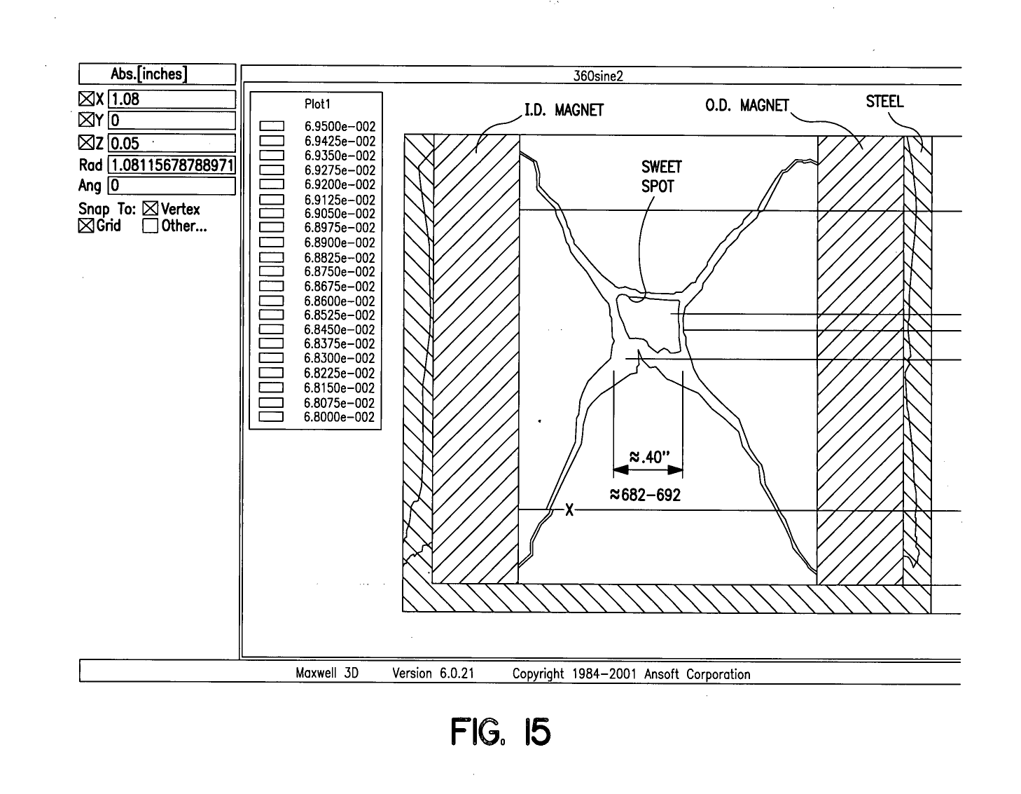

FIGS. 12 and 14, show the tight band of the sine wave curves for the various offset values used. FIGS. 13 and 15 show the size of the ‘sweet spot’ for two configurations at the maximum output position. The range of gauss in the highlighted region is only 10 gauss for a full scale of 1200 gauss or about 0.80% of full scale.

The embodiments that have been described herein, however, are but some of the several which utilize this invention and are set forth here by way of illustration but not of limitation. It is obvious that many other embodiments, which will be readily apparent to those skilled in the art, may be made without departing materially from the spirit and scope of the invention as defined in the appended claims.

1. A phase angle detection system comprising:
rotary sensor comprising a magnet rotating about an axis and a plurality of magnetic field sensors angularly spaced about said axis;
a phase angle pulse modulation circuit and PWM generator circuit coupled to an input signal provided by each of said magnetic field sensors; and
a PWM to analog signal circuit coupled to an output of said modulator and PWM generator circuit.

2. The system of claim 1, wherein said rotary sensor comprises a first and a second magnetic field sensor spaced about 90 degrees apart about said axis.

3. The system of claim 1, wherein said phase angle pulse modulation circuit and PWM generator circuit comprises:
a quadrature oscillator adapted to generate a first signal equal to sin ωt and a second signal cos ωt;
an in phase multiplier adapted to multiply a sine input signal from said rotary sensor by said quadrature oscillator first signal;
a quadrature multiplier adapted to multiply a cosine input signal from said rotary sensor by a quadrature oscillator second signal; and
and adder circuit adapted to sum an output from said phase multiplier and an output from said quadrature multiplier.

4. A rotary sensor system comprising:
a permanent magnet coupled to a rotational input, said magnet rotatable about an axis; and
three magnetic sensors generally evenly spaced around said axis;
wherein said magnetic sensors are adapted to provide respective first, second and third outputs equal to A cos(θ), A cos(θ−120°), and A cos(θ−240°) in response to and angular displacement, θ, of said magnet.

5. The system of claim 4, further comprising a signal processor coupled to said sensor outputs, said processor comprising:
a first multiplying circuit coupled to said first output, multiplying said first output by cos ωt;
a second multiplying circuit coupled to said second output, multiplying said second output by cos(ωt−120°);
a third multiplying circuit coupled to said third output, multiplying said third output by cos(ωt−240°); and
an adding circuit for summing a product of said first, second, and third multiplying circuits.

6. A shaft coupling configuration for a rotary sensor system comprising:
a magnet/rotor assembly rotatably coupled an input shaft, said magnet rotor assembly comprising a Geneva cam feature comprising a first diameter about approximately 180° and a second diameter for approximately 180°;
a magnet tray disposed adjacent to said magnet/rotor assembly, said tray comprising at least one pin adapted to follow said Geneva cam and translate said tray relative to said magnet/rotor assembly in response to said first and second diameter of said Geneva cam.

7. The shaft coupling of claim 6, wherein said Geneva cam feature has an open transition between said first diameter and said second diameter, and wherein said magnet tray comprises at least a first pin adapted to follow said Geneva cam and a second pin and wherein rotation of said open transition across said at least first pin translates said magnet tray, whereby said second pin follows said Geneva cam.
